(19) United States
(12) Patent Application Publication
(10) Pub. No.: US 2018/0230888 A1
(43) Pub. Date: Aug. 16, 2018

(54) Exhaust tip

(71) Applicant: Frank J. Hodges, Corona, CA (US)

(72) Inventor: Frank J. Hodges, Corona, CA (US)

(21) Appl. No.: 15/430,220

(22) Filed: Feb. 10, 2017

(51) Int. Cl. F01N 13/08; F01N 13/16; B60R 13/00; G09F 21/04

(52) U.S. Cl. CPC F01N 13/082; F01N 13/16; F01N 2530/18; G09F 21/04; B60R 13/005

(57) ABSTRACT

The present invention is directed to a vehicle exhaust tip where in cuts are made in the outer surface of the exhaust tip to expose a decorative plate within the exhaust tip. The decorative plate can be colored or have other decorative attributes that can be seen from the outside of the exhaust tip. The decorative elements appear to create three dimensional art due to the shadowing effect of the cut in the outer surface of the exhaust tip.

### FIELD OF THE INVENTION

The present invention is in the field of exhaust tips for vehicles in particular trucks that have custom appearance.

### BACKGROUND

There are numerous silencers and muffler exhaust tips available on the market for vehicle owners that want to customize their vehicles. Most of the aftermarket exhaust tips on the market are decorative in nature given that the exhaust tip is usually the only part of the engine muffler system that is visible to ordinary observers. Presently, most exhaust tips are limited in appearance and customization. U.S. Pat. No. 6,085,863 to Shuen, U.S. Design Pat. No. 413,296 to Hussaini, U.S. Design Pat. No. 384,319 to Harutiunian, U.S. Design Pat. No. 191,509 to Feinberg, and U.S. Design Pat. No. 164,960 to Russell, disclose a decorative exhaustion pipe.

U.S. Pat. No. 6,006,859 to Hussaini discloses a decorative muffler exhaust tip that serves to amplify exhaust noise.

U.S. Pat. No. 4,354,573 to Tabata, et al., and U.S. Pat. No. 5,831,223 to Kesselring, disclose an exhaust piece that serves to further silence the noise from the exhaust of the engine to which the muffler system is connected.

Others, such as U.S. Design Pat. No. 189,573 to Russell, and U.S. Design Pat. No. 133,788 to Koch, disclose a tailpipe tip that diverts the exhaust in a particular direction.

Some, such as U.S. Pat. No. 3,043,097 to Inman, et al., and U.S. Design Pat. No. 247,360 to Hamaguchi, et al., disclose exhaust tips that channel air from around the muffler exhaust tip in a manner that creates a negative pressure on the muffler system when the vehicle is in motion.

U.S. Pat. No. 2,630,835 to Russell discloses a clamping means for an exhaust tail pipe.

U.S. Pat. No. 7,152,710 to Huang et al. discloses an exhaust tip having a set of LEDs that automatically illuminate when heated exhaust gases pass through the tip. Exhaust tips are typically provided for trucks to provide a custom appearance, engine sound, and improve engine performance. The present invention provides new methods and designs to customize exhaust tips. These publications and all other referenced patents are incorporated herein by reference in their entirety. Furthermore, where a definition or use of a term in a reference, which is an incorporated reference here, is inconsistent or contrary to the definition of that term provided herein the definition of the term provided herein applies and the definition of that term in the reference does not apply. Although various improvements are known to the art, all, or almost all of them suffer from one or more than one disadvantage. Therefore, there is a need to provide an improved exhaust tip.

### SUMMARY OF THE INVENTION

In view of the shortcomings of the prior art, it is an object of this invention to provide an exhaust tip with a customizable appearance.

Another object of this invention is to provide an exhaust tip which does not impede engine performance.

Another object of this invention is to provide an exhaust tip which does not impede sound performance.

It is to be understood that the foregoing general description and the following detailed description are exemplary and explanatory only and are not to be viewed as being restrictive of the present invention, as claimed. Further advantages of this invention will be apparent after a review of the following detailed description of the disclosed embodiments and in the appended claims.

### BRIEF DESCRIPTION OF THE DRAWINGS

FIG. 1 shows a preferred embodiment of an exhaust tip from a right side perspective.

FIG. 2 shows a preferred embodiment of an exhaust tip from a left side perspective.

FIG. 3 shows a preferred embodiment of an exhaust tip from an oblique perspective.

FIG. 4 shows a preferred embodiment of an exhaust tip from a back side perspective.

FIG. 5 shows a preferred embodiment of an exhaust tip from a mounting side perspective.

### DETAILED DESCRIPTION OF THE EMBODIMENTS

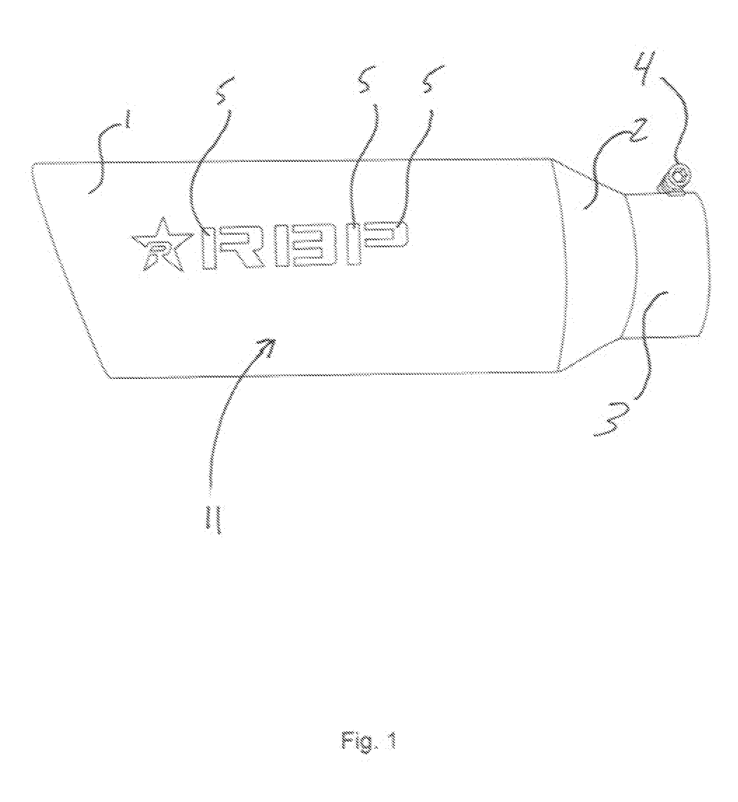

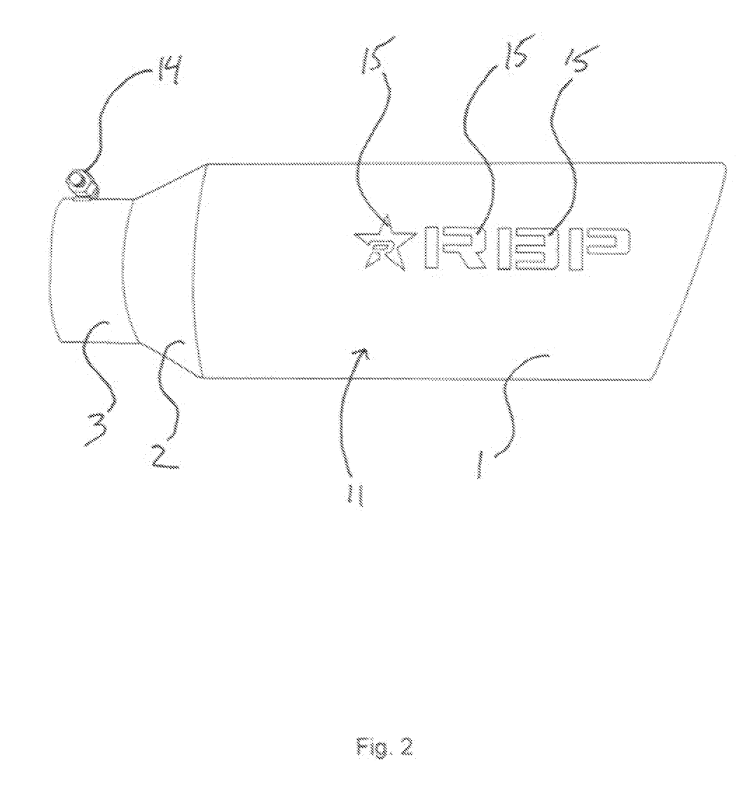

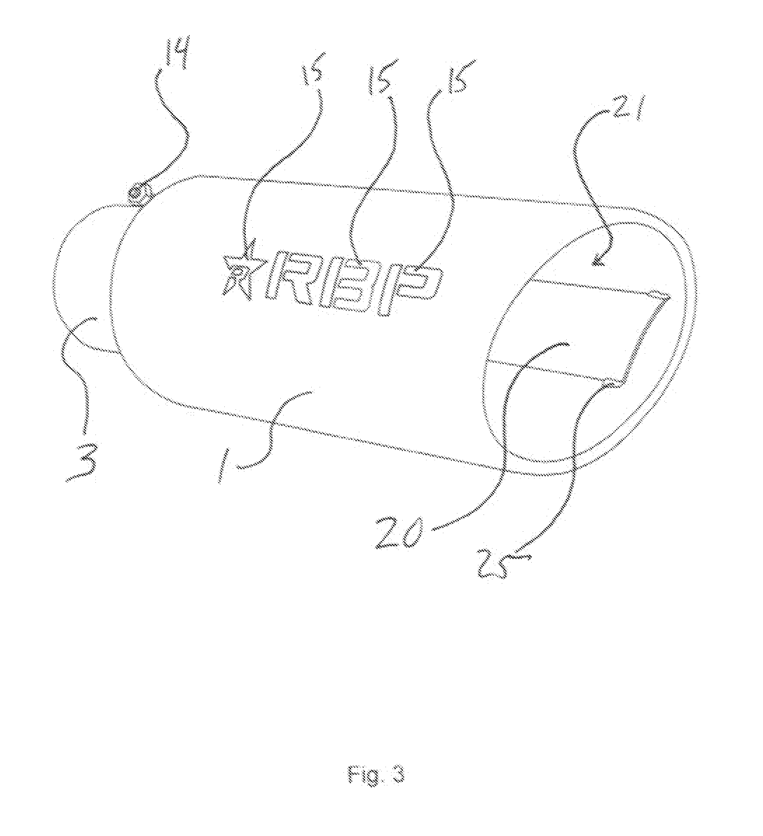

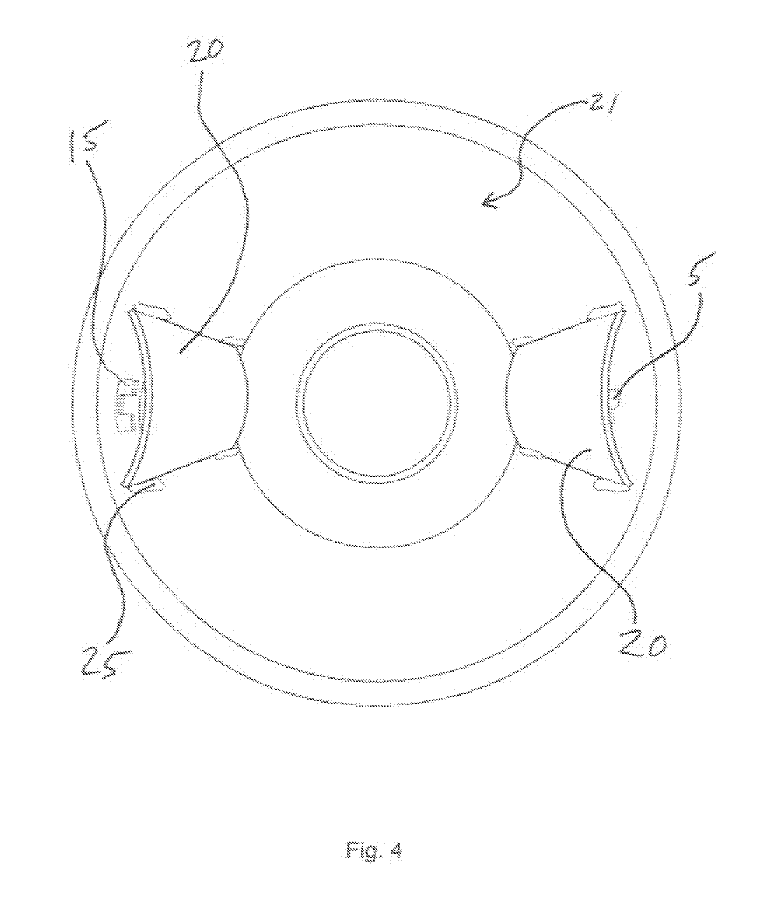

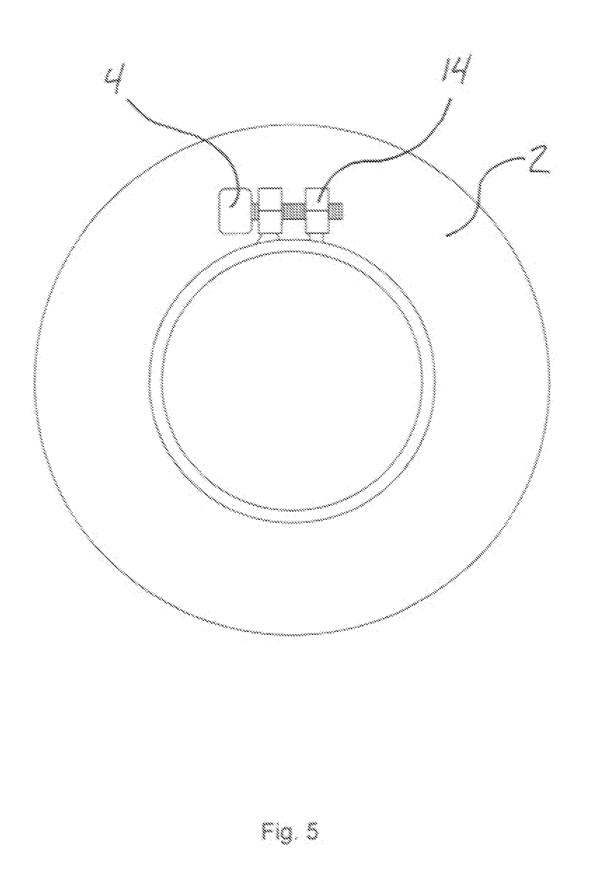

Referring now to the drawings wherein the showings are for purposes of illustrating a preferred embodiment of the present invention and not for purposes of limiting the same, FIGS. 1-5 show an exhaust tip 10. Exhaust tip 10 comprises a main exhaust tip portion 1, a neck portion 2, and an attachment portion 3. The neck portion 2 generally provides for a transition between the main exhaust tip portion 1 and the attachment portion 3 but is not an absolute requirement for the functioning of the present invention. The attachment portion 3 can further comprise a nut 4 and threaded assembly 14 to crimp the exhaust tip 10 on to an existing vehicle tail pipe. The attachment method described is not intended to be limiting additional common attachment means and methods include bolts, screws, welding, adhesives, polymeric ribbons. The exhaust tip 10 further has an outer surface 11 and inner surface 21, wherein the exhaust tip 10 can be single walled or double walled as common in exhaust tip design and manufacturing. The present invention is directed to 3D decoration and logo display wherein the outer surface 11 and inner surface 21 are cut through typically with a laser but any commercial manufacturing cutting methods that can cut through metal, aluminum, steel would work; for example, plasma cutters and water jet cutters. The cutting of the design or logo 5 is shown in FIG. 1 on the right side of the exhaust tip 10. And again, the cutting of the design or logo 15 is shown in FIGS. 2-3 on the left side of the exhaust tip 10. The cutting process can be performed prior to the attachment of a decorative plate 20 or after the attachment of decorative plate 20. If the decorative plate 20 is attached prior to cutting a protective or sacrificial material may be used to protect the decorative plate 20. There is really no limit to the size of the logo 5,15 except for the dimensions of the main exhaust tip portion 1. The decorative plate 20 is attached the inside surface 21 of the exhaust tip. One or more decorative plate 20 may be affixed to the inside surface 21, in this preferred embodiment there are two decorative plate 20 attached. The method of attachment of the decorative plate 20 is typically done with spot welds 25 but could be performed with full length welds or other common means of affixing metal to metal. It is understood that there are heat resistant polymers and ceramic materials that can be substituted for metal commercially available and methods are well known in the automotive industry.

While the main exhaust tip portion 1 dimensions have been disclosed as two to twelve inches in diameter with a preference of three to six inches in diameter. The main exhaust tip portion 1 length can be between eight inches and five and a half feet with a preference of about ten to twenty-four inches in length.

While the decorative plate 20 can be made in almost any shape there are certain preferred embodiments believed to be novel in optimizing 3D reflection and optical illusion. For example, in a preferred embodiment the decorative plate 20 is concave with respect to the inside surface 21. The decorative plate 20 shape can be slightly round, elliptical, hyperbolic, or even flat with respect to the inside surface 21, what is important is that there be a gap between the outer surface 11 and inside surface 21. In an alternative embodiment the decorative plate 20 could be concave and complement the inside surface 21 including any gap. The preferable gap distance is approximately one to two centimeters but could be one to fifteen centimeters for very large diameter main exhaust 1. The length of the decorative plate 20 is preferably shorter than the main exhaust 1 however, in an alternative embodiment it would be possible to have the decorative plate 20 extend beyond the length of the main exhaust and have additional design elements such as anodized aluminum or additional cut out shapes and logos. The surface of the decorative plate 20 can be painted or treated with different coloring agents to create a visible contrast between the decorative plate 20 and the outer surface 11. The decorative plate 20 could be ornamental with different combinations or alone reflective materials for reflecting light.

The foregoing description is, at present, considered to be the preferred embodiments of the present discovery. However, it is contemplated that various changes and modifications apparent to those skilled in the art, may be made without departing from the present discovery. Therefore, the foregoing description is intended to cover all such changes and modifications encompassed within the spirit and scope of the present discovery, including all equivalent aspects. Additional modifications and improvements of the present invention may also be apparent to those skilled in the art. Thus, the particular combination of parts described and illustrated herein in intended to represent only one embodiment of the invention, and is not intended to serve as limitations of alternative devices within the spirit and scope of the invention.

What is claimed is:

1. An exhaust tip comprising a main exhaust tip portion, a neck portion, an attachment portion and a decorative plate affixed to a main exhaust tip portion inside surface and at least one logo cut through the main exhaust tip portion outside surface and inside surface.

2. The exhaust tip of claim 1 wherein the decorative plate is curved or flat.

3. The exhaust tip of claim 1 wherein the decorative plate is shorter or longer than the main exhaust tip portion.

4. The exhaust tip of claim 1 wherein the decorative plate is metal, ceramic and high temperature tolerant polymer.

5. The exhaust tip of claim 1 wherein the decorative plate is painted or anodized.
